(19) United States
(12) Patent Application Publication
(10) Pub. No.: US 2008/0320236 A1
(43) Pub. Date: Dec. 25, 2008

(54) System having cache snoop interface independent of system bus interface

(76) Inventors: Makoto Ueda, Kyoto (JP); Kenichi Tsuchiya, Cary, NC (US); Takeo Nakada, Saitama-ken (JP); Norio Fujita, Shiga-ken (JP)

Correspondence Address: LAW OFFICES OF MICHAEL DRYJA, 1474 N COOPER RD #105-248, GILBERT, AZ, 85233, US

(21) Appl. No.: 11/767,882

(22) Filed: Jun. 25, 2007

(51) Int. Cl. G06F 12/08

(52) U.S. Cl. 711/146; 711/E12.017

(57) ABSTRACT

A system includes processor units, caches, memory shared by the processor units, a system bus interface, and a cache snoop interfaces. Each processor unit has one of the caches. The system bus interface communicatively connects the processor units to the memory via at least the caches, and is a non-cache snoop system bus interface. The cache snoop interface communicatively connects the caches, and is independent of the system bus interface. Upon a given processor unit writing a new value to an address within the memory such that the new value and the address are cached within the cache of the given processor unit a write invalidation event is sent over the cache snoop interface to the caches of the processor units other than the given processor unit. This event invalidates the address as stored within any of the caches other than the cache of the given processor unit.

### FIELD OF THE INVENTION

The present invention relates generally to a system having a number of processors each with its own cache, and more particularly to such a system in which a cache snoop interface among the caches of the processors is implemented independently of a system bus interface communicatively connecting the processors to shared memory of the system.

### BACKGROUND OF THE INVENTION

Multiple-processor computing systems are computing systems that have more than one processor to enhance performance. The multiple processors can be individual discrete processors on different semiconductor dies, or multiple processing units within the same semiconductor die, where the latter is commonly referred to as a “multiple-core” processor in that it has multiple processor units. Multiple-processor computing systems can share system memory. Such shared-memory systems include non-uniform memory architecture (NUMA) shared-memory systems, as well as other types of shared-memory systems.

Typically within multiple-processor, shared-memory computing systems, each processor has its own cache. A cache is a small amount of memory that is used to store recently accessed addresses of the (main) shared memory. As such, for read accesses for instance, a processor does not have to communicate over a system bus interface to again access recently accessed addresses, but rather can access them directly from the cache, which improves performance. For write accesses, the new value to be stored within an address of the (main) shared memory may be stored immediately in both the cache and the (main) shared memory, which is referred to as a write-through configuration of the cache, since the new value is “written through” the cache to the (main) shared memory. Alternatively, the new value may be stored immediately in just the cache, such that at a later time, such as when the address in question is being flushed from the cache to make room for a new address, the new value is then “written back” to the (main) shared memory, in a configuration of the cache that is referred to as a write-back configuration.

Within a multiple-processor, shared-memory system in which the processors have their own caches, cache consistency, or “coherency,” has to be maintained. That is, it is important to ensure that if one processor has written a new value to a given address of the (main) shared memory, other processors that are caching an old value of this address within their caches realize that this old value is no longer valid. Therefore, it is said that the caches have to be “snooped,” so that caches are informed when new values written to addresses within any of the caches.

A multiple-processor, shared-memory system typically includes a system bus interface that communicatively connects the processors to the (main) shared memory through at least the caches of the processors. A cache coherency protocol is provided within this system bus interface. Thus, when new values are written to addresses within the (main) shared memory over the system bus interface, the protocol in question takes care of informing the caches that the old values that they may be caching for this address are no longer valid. In this way, cache coherency is maintained by proper notification to the caches when the values they are caching for addresses are no longer valid.

Implementing cache coherency within the system bus interface connecting the processors to the (main) shared memory of a multiple-processor, shared-memory system has proven disadvantageous, however. Within such topologies, bus transactions of each processor are monitored by other processors. As such, all address-related communications have to be serialized and broadcast, which becomes problematic when higher memory bandwidth is achieved by using crossbar buses or NUMA topologies. This is because memory access concurrency within such topologies is substantially diminished by the added cache snoop-related requirements. Expensive hardware, such as copy-tag and cache directories, have been developed to improve the scalability of system bus interface-based cache coherency (i.e., “snoop”) protocols. However, due to their expensive, utilization of such hardware has been limited to relatively high-end servers.

For these and other reasons, therefore, there is a need for the present invention.

### SUMMARY OF THE INVENTION

The present invention

relates generally to a multiple-processor, shared-memory system having a cache snoop interface that is independent of the system bus interface interconnecting the processors to the shared memory. A system of one embodiment of the invention includes processor units, a cache for each processor unit, memory shared by the processor units, a system bus interface, and a cache snoop interface. The system bus interface communicatively connects the processor units to the memory via at least the caches. The system bus interface is a non-cache snoop system bus interface. The cache snoop interface communicatively connects the caches, and is independent of the system bus interface. Upon a given processor unit writing a new value to an address within the memory such that the new value and the address are cached within the cache of the given processor unit a write invalidation event is sent over the cache snoop interface to the caches of the other processor units. The write invalidation event results in the address as stored within any of the caches of these other processor units being invalidated.

A method of an embodiment of the invention includes a first processor unit writing a new value to an address within shared memory. A cache of the first processor unit caches the new value and the address. A write invalidation event is sent over a cache snoop interface to caches of one or more second processor units. The cache snoop interface is independent of a system bus interface communicatively connecting the first and the second processor units to the shared memory. The address within the cache of each second processor unit that is currently storing the address is thus invalidated.

At least some embodiments of the invention provide for advantages over the prior art. The cache snoop interface is independent of the system bus interface. As such, a designer can select a system bus interface without having to worry about cache coherency For example, the designer may choose an inexpensive system bus interface for access to shared memory, or a crossbar bus to improve memory bandwidth. The latter may be inexpensive when the system bar interface is not required to support cache snooping. Furthermore, such crossbar buses provide increased memory bandwidth because address transfers by multiple processors have concurrency when caching snooping is not implemented within the crossbar buses.

Furthermore, timing of the broadcast of write invalidation events over the cache snoop interface can be delayed from the system bus interface access that caused the broadcast. The broadcast can be delayed until the next synchronization event, for instance, where the data written by one processor unit is shared with the other processor units. Such delay is possible where the caches in question are “write-through” caches, in which memory writes are immediately written to the shared memory at least substantially at the same time as they are written to the caches in question. By comparison, if the caches were “write-back” caches, in which memory writes are not written to the shared memory until their relevant addresses are being flushed from the caches in question, and as is the case where the system bus interface has to support cache snooping, the write invalidation event has to be completed before the system bus interface is accessed. As such, memory bandwidth and/or scalability are hindered.

It is noted that the processor units can be individual processors on separate semiconductor dies, or processors that are part of the same semiconductor die, where the latter is commonly referred to as a “multiple core” semiconductor design. Still other aspects, advantages, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system having a cache snoop interface that is independent of a system bus interface of the system, according to an embodiment of the invention.

FIG. 2 is a diagram of a system having a cache snoop interface that is independent of a system bus interface of the system, according to another embodiment of the invention.

FIG. 3 is a flowchart of a method for employing a system having a cache snoop interface that is independent of a system bus interface of the system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

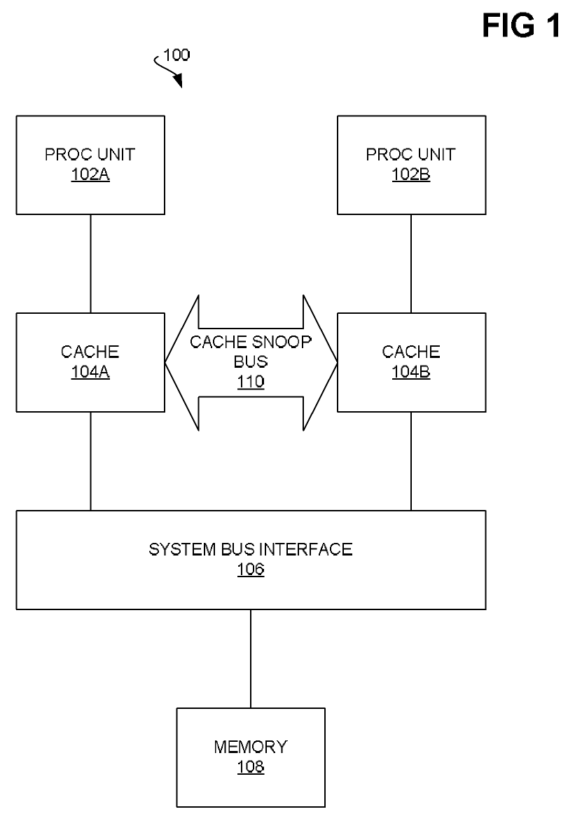

FIG. 1 shows a system 100, according to an embodiment of the invention. The system 100 may be a computing system. The system 100 includes processor units 102A and 102B, collectively referred to as the processor units 102, caches 104A and 104B, collectively referred to as the caches 104, a system bus interface 106, a memory 108, and a cache snoop interface 110. As can be appreciated by those of ordinary skill within the art, the system 100 can and typically will include other components, in addition to and/or in lieu of those depicted in FIG. 1. For instance, the system 100 typically will include various cache controllers, memory controllers, input/output (I/O) components, and other types of components, which are not shown in FIG. 1.

The processor units 102 may be separate processors on separate semiconductor dies, or they may be processor units of the same processor on the same semiconductor die. In the latter situation, the processor encompassing the processor units 102 is referred to as a “multiple-core” processor in some situations. Two processor units 102 are depicted in FIG. 1. However, there may be more than two processor units 102 in other embodiments of the invention.

The processor unit 102A is said to have the cache 104A and the processor unit 102B is said to have the cache 104B. The caches 104 temporarily cache values stored in memory addresses of the memory 108, which is system memory shared by both the processor units 102 in one embodiment. The processor units 102 access the memory 108 via the system bus interface 106. Therefore, by caching recently accessed addresses within the memory 108 in the caches 104, the processor units 102 have enhanced performance, since they do not have to traverse the system bus interface 106. The cache 104A temporarily stores memory addresses and values of the memory 108 for the processor unit 102A, and the cache 104B temporarily stores memory address and values of the memory 108 for the processor unit 102B.

The caches 104 are generally each much smaller than the memory 108 in size. The caches 104 are said to each include a number of cache lines. A given line of a cache stores a memory address of the memory 108 to which the line relates, and the value of this address of the memory 108. When a new value is written to the memory address by a processor unit, in one embodiment the new value is written to both the cache line of the cache in question and the memory 108 substantially simultaneously and immediately, where the cache is in a “write through” configuration. By comparison, where a cache is in a “write back” configuration, a new value written to the memory address by a processor unit results in the new value being written immediately to the cache line of the cache in question, but is not written back to the memory 108 until the cache line is being flushed from the cache. The cache line may be flushed when it is needed to cache a different memory address of the memory 108, and the cache line in question is the oldest cache line in terms of most recent usage.

As has been noted, the system bus interface 106 communicatively connects the shared memory 108 to the processor units 102, via or through at least the caches 104. The system bus interface 106 is typically implemented in hardware. The system bus interface 106 further is a non-cache snoop system bus interface. That is, the system bus interface 106 does not implement any type of cache snooping, cache consistent, or cache coherency protocol. Furthermore, no cache-related information is ever sent over the system bus interface 106. The system bus interface 106 is thus completely unrelated to maintaining coherency or consistent of the caches 104.

Rather, the system 100 includes a separate cache snoop bus 110 (i.e., an interface) for these purposes. The cache snoop bus 110 is independent of the system bus interface 106. The cache snoop bus 110 may be implemented in hardware, software, or a combination of hardware and software. For instance, where the caches 104 are communicatively connected to one another within the same semiconductor die, the cache snoop bus 110 can leverage this communicative connection. The cache snoop bus 110 provides for the maintenance of coherency of the caches 104, as is now described by representative example.

For example, the processor unit 102A may be writing a new value to the memory address ABCD of the shared memory 108. In response, the cache 104A caches in a cache line this new value and this memory address. Furthermore, a write invalidation event related to the memory address ABCD is sent to the caches of all the other processor units. As such, the cache 104B of the processor unit 102B receives the write invalidation event. In response, if the cache 104B is currently caching an old value for the memory address ABCD, it invalidates this old value. That is, the cache 104B indicates therein that the old value for this memory address is no longer valid by, for instance, setting what is referred to as a “dirty bit” within the cache for this memory address.

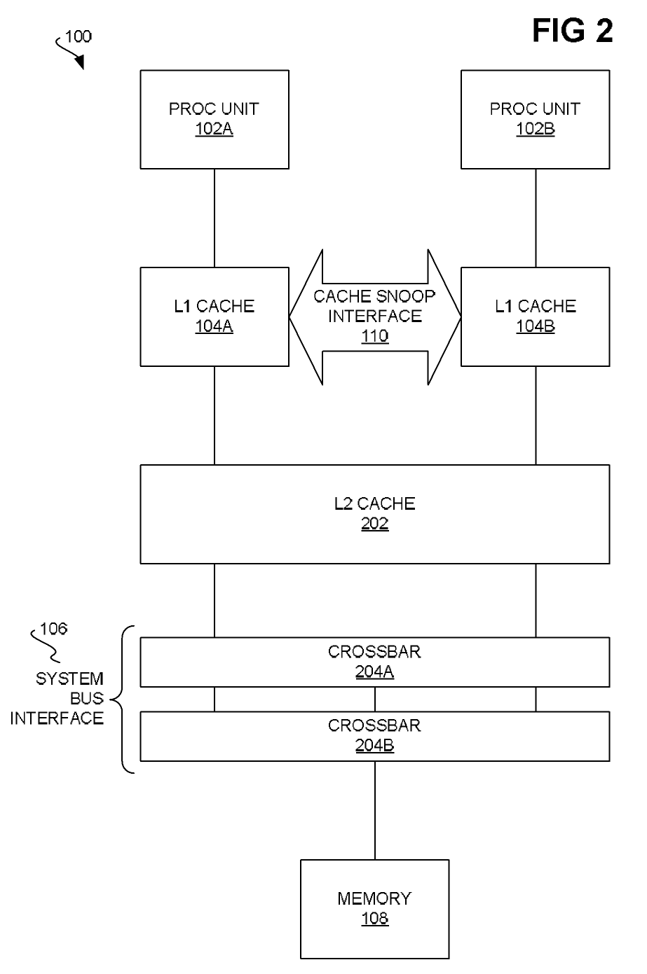

An overview of a representative embodiment of the invention has been provided in relation to FIG. 1. What follows is a description of a more detailed embodiment of the invention, in relation to FIG. 2. Those of ordinary skill within the art can appreciate, however, that both the embodiments of FIGS. 1 and 2 are amenable to variations and modifications, without deviating from the scope of the present invention as recited in the claims at the end of this patent application.

FIG. 2 thus shows the system 100, according to another embodiment of the invention. The system 100 in the embodiment of FIG. 2 is consistent with the system 100 in the embodiment of FIG. 1. There are three primary modifications between the system 100 of FIG. 1 and the system 100 of FIG. 2. First, the caches 104 are specifically delineated as level-one (“L1”) caches. Second, a level-two (“L2”) cache 202 has been included. Third, the system bus interface 106 is specifically implemented having a number of crossbars 204A and 204B, collectively referred to as the crossbars 204. While all three modifications have been made to the system 100 of FIG. 1 to result in the system 100 of FIG. 2, those of ordinary skill within the art can appreciate that in another embodiments, just one or more, and not all three, of these modifications may be made.

The L1 caches 104 are generally the smallest yet fastest caches present within processors. The L1 caches 104 in the embodiment of FIG. 2 operate in a “write through” configuration. While the L1 cache 104A is for and of the processor unit 102A and the L1 cache 104B is for and of the processor unit 102B, the L2 cache 202 is shared between the processor units 102 and thus between the L1 caches 104, which is advantageous insofar as it leverages a single L2 cache 202 for all the processor units 102. The L2 cache 202 is generally larger than any of the L1 caches 104, but is somewhat slower than the L1 caches 104. The L2 cache 202 in the embodiment of FIG. 2 operates in a “write back” configuration.

For example, a processor unit may write a new value to a memory address of the shared memory 108. As a result, this new value for this memory address is immediately cached within the L1 cache of the processor unit. This new value for this memory address is also immediately written through to the L2 cache 202, and the L2 cache likewise caches this new value for this memory address. However, the L2 cache 202 does not immediately write through to the memory 108. Rather, the new value for this memory address is written back to the memory 108 when, for instance, the cache line within the L2 cache 202 that stores this memory address and new value is being flushed, or at another time. Just at this time is the new value of this memory address written back to the memory 108. Having an L2 cache 202 in a “write back” configuration serves to mitigate the increased bandwidth resulting from the L1 caches 104 being in a “write through” configuration.

The system bus interface 106 is implemented in the embodiment of FIG. 2 as a number of crossbars 204. While there are two such crossbars 204 depicted in FIG. 2, in other embodiments there may be more than two crossbars 204. As can be appreciated by those of ordinary skill within the art, implementing the system bus interface 106 using the crossbars 204 provides for increased memory bandwidth, because address transfers by the processor units 102 have concurrency. This is particularly the case where, as in the embodiment of FIG. 2, the system bus interface 106 does not have any cache snoop functionality, just as in FIG. 1.

Therefore, in the embodiment of FIG. 2, the cache snoop bus 110 operates the same way as has been described in relation to FIG. 1. Likewise, the system bus interface 106 in the embodiment of FIG. 2 does not have implemented therein any type of cache snoop protocol, and is not part of maintaining the coherency of the caches 104. Rather, the cache snoop bus 110, which is still independent of the system bus interface 106, maintains coherency of the caches 104 by itself. It is noted that coherency of the L2 cache 202 is not an issue, since there is just one L2 cache 202, as opposed to more than one L1 cache 104.

In one embodiment, write invalidation events, as have been described, are transmitted from one of the caches 104 to all the other caches 104 by being broadcast over the cache snoop bus 110. Broadcast is a one-to-many transmission, as opposed to a one-to-one transmission, as can be appreciated by those of ordinary skill within the art. Furthermore, such broadcast or other transmission may be delayed by one or more system clock cycles. For instance, it may be delayed until a cache-synchronization event occurs, which is an event that causes all the caches 104 to exchange recent write invalidation events (i.e., since the last cache-synchronization event) so that they can become synchronized with one another. Such cache-synchronization events may occur on a regular and periodic basis.

As another example, a write invalidation event may be delayed such that it is broadcast or otherwise transmitted after compression with one or more other write invalidation events relating to the same address within the memory 108. That is, if a given processor unit, for instance, is constantly writing to the same memory address, periodically the write invalidation events relating to this memory address may be compressed into a single delayed write invalidation event and later transmitted to the caches of the other processor units. In this respect, write invalidation information is received by other caches in a delayed manner, but less information is transmitted over the cache snoop bus 110 overall.

Besides write invalidation events, other types of cache-related events may also be transmitted between the caches 104 over the cache snoop bus 110. For instance, as has been described, cache synchronization events may be transmitted over the cache snoop bus 110, in response to which the caches 104 exchange write invalidation events. As another example, other types of cache control operation-related events may be transmitted over the cache snoop bus 110, such as commands causing the caches 104 to flush themselves of all cached memory addresses of the memory 108, and so on.

It is also noted that in one embodiment, the broadcast or other transmission of a write invalidation event over the cache snoop bus 110 may be qualified by a memory coherent attribute that is recorded within a translation lookaside buffer (TLB) for or of the processor unit having the originating cache in question. A TLB is another type of cache that is employed to improve the performance of virtual address translation within a processor unit, as can be appreciated by those of ordinary skill within the art. Setting a memory coherent attribute within the TLB of a processor indicates to the TLB that the memory address of the memory 108 that is having a new value written thereto may be invalid within the TLB itself, similar to a “dirty bit” within other types of caches.

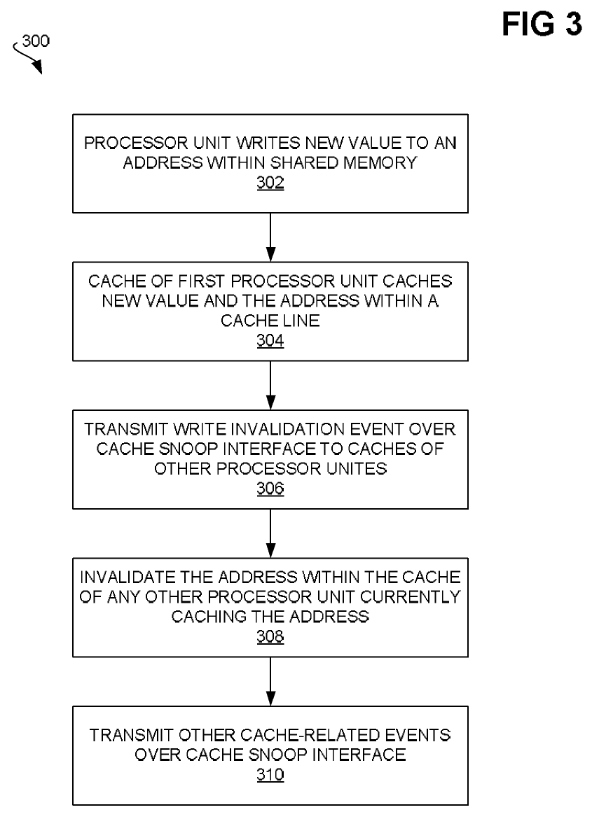

In conclusion, FIG. 3 shows a method 300 that summarizes the operation of the system 100, according to an embodiment of the invention. A processor unit writes a new value to an address within shared memory (302). As a result, the cache of this processor unit caches the new value and the address within a cache line thereof (304). This cache may be an L1 cache, as has been described, operating in a “write through” configuration, where there is also an L2 cache shared among all the processors that operates in a “write back” configuration, as has also already been described.

A write invalidation event is transmitted over a cache snoop interface to the caches of the other processor units (306). The transmission of the write invalidation event can occur over the cache snoop interface in one or more of a number of different manners. The transmission may be delayed by at least one clock cycle, as compared to the clock cycle in which the cache caches the new value and the address, for instance. As another example, the write invalidation event may be compressed with one or more other write invalidation events relating to the same address, within a single delay write invalidation event that is later transmission over the cache snoop interface. As a third example, the write invalidation event may specifically be transmitted by being broadcast to the other processor units.

In response to receiving the write invalidation event over the cache snoop interface, the other caches of the other processors invalidate this address within any of their memory lines that are currently caching the address (308). As a result, cache coherency is maintained across all the individual caches of the processor units, without having to employ a relatively expensive system bus interface that implements a cache coherency protocol, as has been described. As has also already been described, other types of cache-related events can be transmitted over the cache snoop interface (310), too, such as cache control operation-related events and/or cache synchronization events.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

We claim:

1. A system comprising:
a plurality of processor units;
a plurality of caches, each processor unit having one of the caches;
memory shared by the processor units;
a system bus interface communicatively connecting the processor units to the memory via at least the caches, the system bus interface being a non-cache snoop system bus interface; and,
a cache snoop interface communicatively connecting the caches, the cache snoop interface independent of the system bus interface,
wherein upon a given processor unit writing a new value to an address within the memory such that the new value and the address are cached within the cache of the given processor unit, a write invalidation event is sent over the cache snoop interface to the caches of the processor units other than the given processor unit to invalidate the address as stored within any of the caches other than the cache of the given processor unit.

2. The system of claim 1, wherein the processor units are individual processors on separate semiconductor dies.

3. The system of claim 1, wherein the processor units are part of a same multiple-core processor on a single semiconductor die.

4. The system of claim 1, wherein the caches are configured to operate in a write-through mode, such that upon a given processor unit writing a new value to an address within the memory, the new value is immediately written to the memory and at least substantially simultaneously the new value and the address are cached within the cache of the given processor unit.

5. The system of claim 1, wherein the caches are level-one (L1) caches.

6. The system of claim 1, wherein the caches are first caches, the system further comprising a second cache shared by all the processor units, the first caches configured to operate in a write-through mode and the second cache configured to operate in a write-back mode, such that upon a given processor unit writing a new value to an address within the memory, the new value and the address are cached within the first cache of the given processor unit and within the second cache, and the new value is not written to the memory until the address is being flushed from the second cache.

7. The system of claim 6, wherein the second cache is a level-two (L2) cache.

8. The system of claim 1, wherein the cache snoop interface is implemented in one or more of software and hardware.

9. The system of claim 1, wherein upon the given processor unit writing the new value to the address within the memory such that the new value and the address are cached within the cache of the given processor, transmission of the write invalidation event over the cache snoop interface to the caches of the processors other than the given processor is delayed.

10. The system of claim 9, wherein transmission of the write invalidation event over the cache snoop interface to the caches of the processors other than the given processor is delayed by at least one clock cycle.

11. The system of claim 9, wherein transmission of the write invalidation event over the cache snoop interface to the caches of the processors other than the given processor is delayed until a cache-synchronization event occurs.

12. The system of claim 9, wherein the write invalidation event is compressed with one or more other write invalidation events also relating to the address within a single delayed write invalidation event that is transmitted over the cache snoop interface.

13. The system of claim 1, wherein cache-related events other than write invalidation events are also communicated among the caches over the cache snoop interface, the cache-related events other than write invalidation events including cache control operation-related events and cache synchronization events.

14. The system of claim 1, wherein sending of the write invalidation event over the cache snoop interface to the caches of the processors other than the given processor is a broadcast of the write invalidation event over the cache snoop interface.

15. The system of claim 1, wherein the broadcast of the write invalidation event over the cache snoop interface is qualified by a memory coherent attribute recorded within a translation lookaside buffer (TLB).

16. A method comprising:
a first processor unit writing a new value to an address within shared memory;
a cache of the first processor unit caching the new value and the address;
transmitting a write invalidation event over a cache snoop interface to caches of one or more second processor units, the cache snoop interface independent of a system bus interface communicatively connecting the first and the second processor units to the shared memory; and,
invalidating the address within the cache of each second processor unit that is currently storing the address.

17. The method of claim 16, wherein the caches of the first and the second processor unit are first caches, the method further comprising a second cache shared by the first and the second processor units caching the new value and the address upon the first processor writing the new value to the address within the shared memory, such that the new value is actually not written to the address within the shared memory until the address is being flushed from the second cache,
such that the first caches operate in a write-through mode, and the second cache operates in a write-back mode.

18. The method of claim 16, wherein transmitting the write invalidation event over the cache snoop interface comprises one or more of:
delaying transmission of the write invalidation event by at least one clock cycle as compared to a clock cycle in which the cache of the first processor unit caches the new value and the address;
compressing one or more other write invalidation events also relating to the address within a single delayed write invalidation event that is transmitted over the cache snoop interface; and,
broadcasting the write invalidation event over the cache snoop interface.

19. The method of claim 16, further comprising transmitting cache-related events other than write invalidation events over the cache snoop interface, the cache-related events other than write invalidation events including cache control operation-related events and cache synchronization events.

20. A system comprising:
a plurality of processor units;
a plurality of caches, each processor unit having one of the caches;
memory shared by the processor units;
a system bus interface communicatively connecting the processor units to the memory via at least the caches, the system bus interface being a non-cache snoop system bus interface; and,
cache snoop means for sharing at least write invalidation cache-related events among the caches of the processors, the cache snoop means independent of the system bus interface,
wherein upon a given processor unit writing a new value to an address within the memory such that the new value and the address are cached within the cache of the given processor unit, a write invalidation event is sent to the caches of the processor units other than the given processor unit to invalidate the address as stored within any of the caches other than the cache of the given processor unit.
